(19) United States
(12) Patent Application Publication
(10) Pub. No.: US 2025/0361123 A1
(43) Pub. Date: Nov. 27, 2025

(54) CRANE

(71) Applicant: TADANO LTD., Kagawa (JP)

(72) Inventors: Takashi KAWANO, Kagawa (JP); Kimihiko TERATA, Kagawa (JP); Shota NAKAMATSU, Kagawa (JP)

(73) Assignee: TADANO LTD., Kagawa (JP)

(21) Appl. No.: 18/872,489

(22) PCT Filed: Jun. 15, 2023
(86) PCT No.: PCT/JP2023/022316

§ 371 Date: Dec. 6, 2024

(30) Foreign Application Priority Data
Jun. 24, 2022 (JP) 2022-102119

(51) Int. Cl. B66C 23/38; B66C 13/12

(52) U.S. Cl. CPC B66C 23/38; B66C 13/12; B66C 2700/082

(57) ABSTRACT

This crane has a turning body that supports a boom, the crane including: a travel body that has a frame for supporting a front-side axle and a rear-side axle; and a motor that is disposed below the frame and between the front-side axle and the rear-side axle, the motor being connected to the front-side axle and the rear-side axle.

### TECHNICAL FIELD

The present invention relates to a crane.

### BACKGROUND ART

Patent Literature 1 discloses a mobile crane which includes a lower traveling body having a traveling function and an upper turning body provided in a turnable state on an upper portion of the lower traveling body. The lower traveling body includes an engine and travels on the basis of power of the engine.

### CITATION LIST

### Patent Literature

Patent Literature 1: JP 2012-96928 A

### SUMMARY OF THE INVENTION

### Problems to be Solved by the Invention

In recent years, there has been a demand for electrification of cranes as described above from the viewpoint of environmental protection and the like.

An object of the present invention is to provide a crane that can travel by electric power.

### Solutions to Problems

One aspect of a crane according to the present invention is a crane having a turning body that supports a boom, the crane including:
a travel body that has a frame for supporting a front-side axle and a rear-side axle; and
a motor that is disposed below the frame and between the front-side axle and the rear-side axle, the motor being connected to the front-side axle and the rear-side axle.

### Effects of the Invention

According to the present invention, it is possible to provide the crane that can travel by electric power.

### BRIEF DESCRIPTION OF DRAWINGS

FIG. 1 is a schematic view of a mobile crane according to an embodiment.

FIG. 2 is a block diagram schematically illustrating a configuration of a high-voltage system.

FIG. 3 is a perspective view of a lower traveling body in which a configuration is partially omitted.

FIG. 4 is a schematic view illustrating a state of the lower traveling body as viewed from below.

FIG. 5 is a schematic view illustrating a state of a periphery of a motor as viewed from a left side.

FIG. 6 is a schematic view illustrating a state of the periphery of the motor as viewed from above.

FIG. 7 is a schematic view illustrating a battery periphery as viewed from above.

FIG. 8 is a schematic view illustrating an example of a multi-axle vehicle.

FIG. 9 is a schematic view illustrating an example of the multi-axle vehicle.

### DESCRIPTION OF EMBODIMENTS

Hereinafter, an example of embodiments according to the present invention will be described in detail based on the drawings. Note that a crane according to the embodiment described below is an example of a crane according to the present invention, and the present invention is not limited to the embodiment described below.

### Embodiment

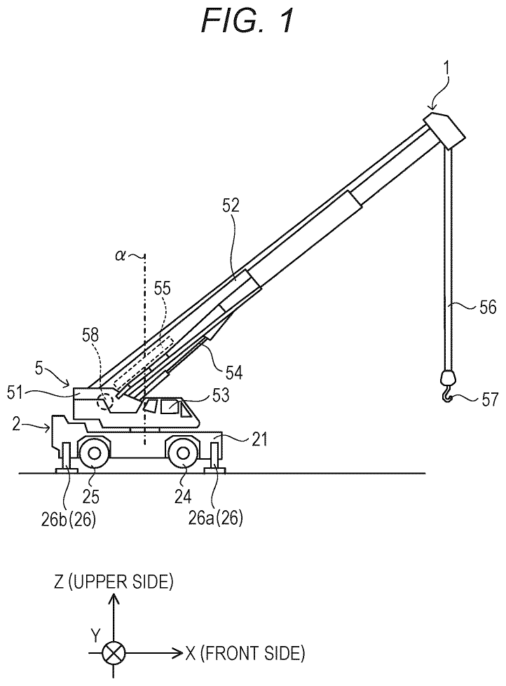

FIG. 1 is a schematic view of a mobile crane 1 (in the illustrated case, rough terrain crane) according to the present embodiment. The mobile crane is an all-terrain crane, a truck crane, a truck loader crane (also referred to as a cargo crane), or the like. However, the crane according to the present invention may be various cranes.

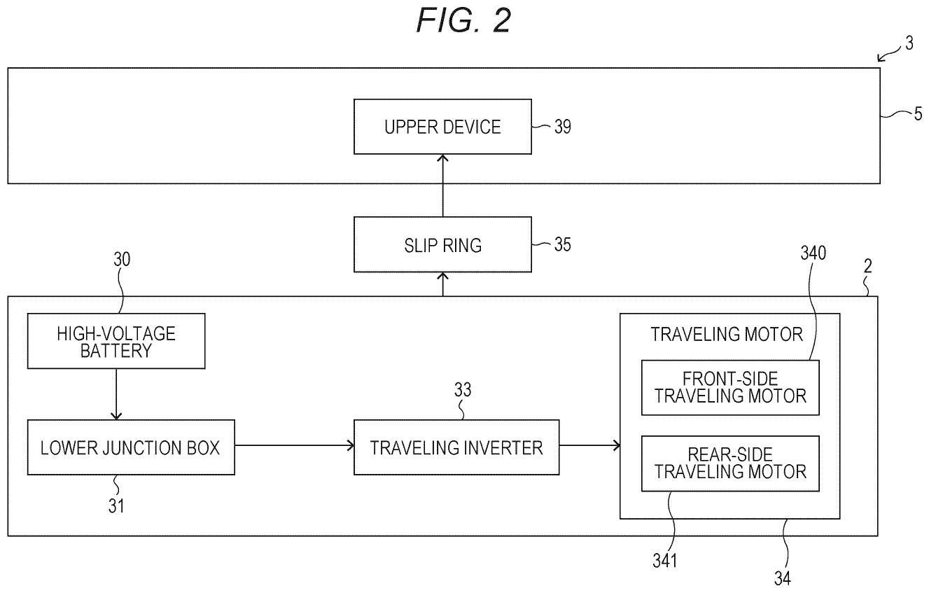

The mobile crane 1 includes a lower traveling body 2 and an upper turning body 5. The mobile crane 1 is an electric crane including a high-voltage battery 30 (see FIG. 2). The mobile crane 1 travels on the basis of the electric power supplied from the high-voltage battery 30. That is, the mobile crane 1 does not include an engine.

In addition, the mobile crane 1 executes a motion other than traveling (for example, a crane operations and/or heating) on the basis of the electric power supplied from the high-voltage battery 30. The crane operation is, for example, a turning motion and/or a winch motion in a cargo conveyance operation. Hereinafter, a specific configuration of the mobile crane 1 will be described.

First, the configuration of the upper turning body 5 will be described with reference to FIGS. 1 and 2. FIG. 1 is a schematic view of the mobile crane 1. FIG. 2 is a block diagram schematically illustrating a configuration of a high-voltage system 3 mounted on the mobile crane 1.

Note that the high-voltage system 3 is a system using a high-voltage battery 30 to be described below as a power source, and includes the high-voltage battery 30 and an element electrically connected to the high-voltage battery 30. Although FIG. 2 illustrates main elements constituting the high-voltage system 3, the high-voltage system 3 may include elements other than the main elements illustrated in FIG. 2.

The upper turning body 5 is provided on the upper portion of the lower traveling body 2, and can turn about a turning center axis o with respect to the lower traveling body 2. The upper turning body 5 includes a turning table 51, a telescopic boom 52, and a cab 53.

The turning table 51 is supported on the upper portion of the lower traveling body 2 via a bearing (not illustrated). The turning table 51 turns on the basis of power generated by a turning actuator (not illustrated) provided in the upper turning body 5. In the case of the present embodiment, the turning actuator is a hydraulic motor. The motor operates on the basis of the supply and discharge of hydraulic oil. The hydraulic oil is supplied from the lower traveling body 2. Note that the turning actuator may be an electric motor. In this case, the electric motor for turning is driven on the basis of the electric power supplied from the high-voltage battery 30 to be described below.

The telescopic boom 52 is supported by the turning table 51 and has a plurality of telescopically combined booms. The telescopic boom 52 can change a derricking angle (derrick) on the basis of the power generated by a derricking cylinder 54.

The derricking cylinder 54 is a telescopic hydraulic cylinder and is provided in the upper turning body 5. The derricking cylinder 54 operates on the basis of the supply and discharge of hydraulic oil. Note that the hydraulic oil is supplied from the lower traveling body 2.

In addition, the telescopic boom 52 expands and contracts on the basis of the power generated by a telescopic cylinder 55. The telescopic cylinder 55 is a hydraulic cylinder and is provided inside the telescopic boom 52. The telescopic cylinder 55 operates on the basis of the supply and discharge of hydraulic oil. Note that the hydraulic oil is supplied from the lower traveling body 2.

In addition, the telescopic boom 52 supports a wire rope 56. The wire rope 56 hangs down from a distal end portion of the telescopic boom 52, and a hook 57 is provided at the distal end portion. A part of the wire rope 56 is wound around a winch 58.

The winch 58 is driven (rotates) on the basis of the power generated by a winch actuator (not illustrated). In the case of the present embodiment, the winch actuator is provided on the turning table 51 and is a hydraulic motor. The motor operates on the basis of the supply and discharge of hydraulic oil. The hydraulic oil is supplied from the lower traveling body 2.

When the winch 58 rotates, the wire rope 56 is wound up or unwound according to the rotation direction of the winch 58. Note that the motor for winch may be an electric motor. In this case, the electric motor for winch is driven on the basis of the electric power supplied from the high-voltage battery 30 to be described below.

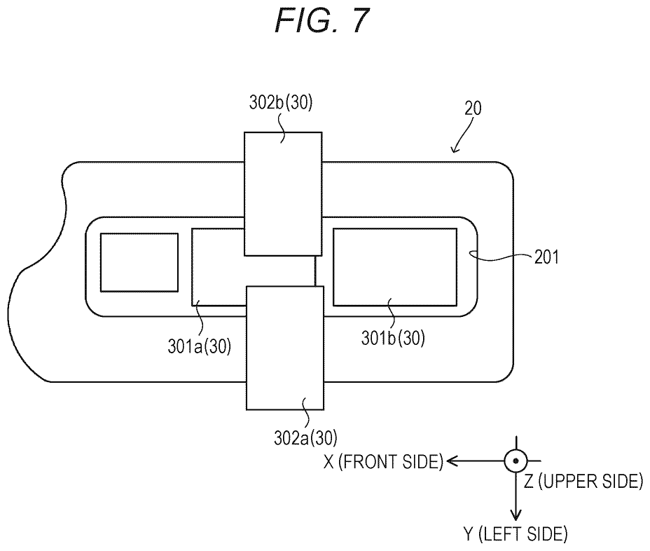

Next, the lower traveling body 2 will be described with reference to FIGS. 1 to 7. Note that in describing the structure of the lower traveling body 2, an orthogonal coordinate system (X, Y, Z) illustrated in each drawing is used. An X direction coincides with the front-rear direction of the lower traveling body 2. A +side in the X direction coincides with the front side of the lower traveling body 2. A −side in X direction coincides with the rear side of the lower traveling body 2. A Y direction coincides with the left-right direction of the lower traveling body 2. A +side in the Y direction corresponds to the left side when the front is viewed from the lower traveling body 2. A −side in the Y direction corresponds to the right side when the front is viewed from the lower traveling body 2. A Z direction coincides with the up-down direction of the lower traveling body 2. A +side in the Z direction coincides with the upper side of the lower traveling body 2. A −side in the Z direction corresponds to the lower side of the lower traveling body 2.

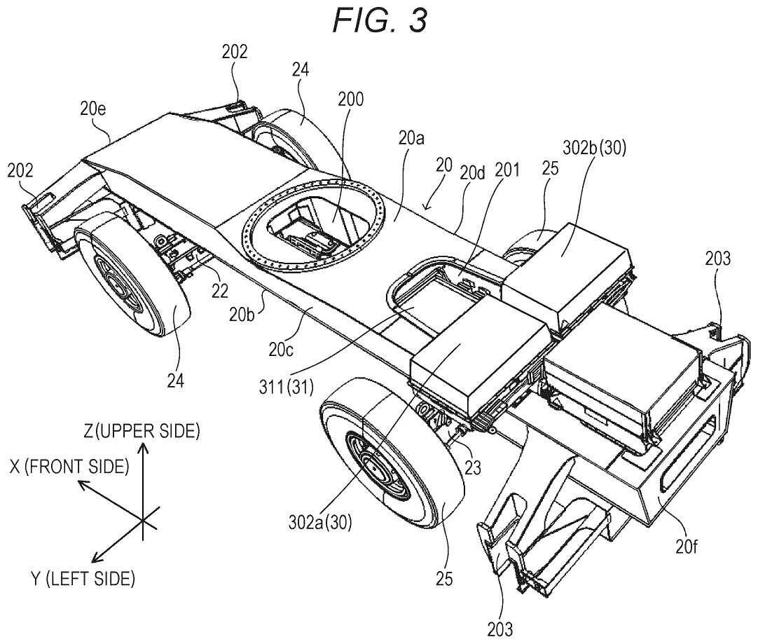

The lower traveling body 2 can travel by electric power. Specifically, as illustrated in FIGS. 1 and 3, the lower traveling body 2 includes a frame 20, a body 21, a front-side axle 22, a rear-side axle 23, front-side tires 24, rear-side tires 25, and an outrigger 26.

The frame 20 is a box-shaped member extending in the front-rear direction and having a rectangular cross-sectional shape, for example, and constitutes a framework of the lower traveling body 2. The frame 20 includes an upper-side plate 20a, a lower-side plate 20b, a left-side plate 20c, a right-side plate 20d, a front-side plate 20e, and a rear-side plate 20f.

In addition, the frame 20 has a slip ring arrangement space 200 formed by a through hole penetrating the frame 20 in the up-down direction. The slip ring arrangement space 200 is provided at a central position between the front-side axle 22 and the rear-side axle 23 to be described below in the frame 20.

In addition, the frame 20 has a battery housing space 201 formed by a through hole penetrating the frame 20 in the up-down direction. The battery housing space 201 is provided in the frame 20 at a position extending from the upper side to the rear end portion of the rear-side axle 23. That is, the battery housing space 201 may be considered to be provided in the rear portion of the frame 20. In the frame 20, a cross-sectional shape of a portion where the battery housing space 201 is formed is a closed cross section configured by a plurality of continuous plates. Note that the cross section of the frame 20 means a section of the frame 20 cut along a YZ plane.

The position of the battery housing space is not limited to the illustrated case. The battery housing space may be provided in the frame 20 at a position extending from the upper side to the front end portion of the front-side axle 22. Also in this case, the battery housing space may be formed by a through hole penetrating the frame 20 in the up-down direction.

The frame 20 has a pair of front-side outrigger support portions 202 at the front end portion. The frame 20 has a pair of rear-side outrigger support portions 203 at the rear end portion.

The body 21 (see FIG. 1) is a member constituting the outer shape of the lower traveling body 2, and is supported by the frame 20.

The front-side axle 22 is an axle member extending in the left-right direction, and is supported by a portion of the frame 20 near the front end of the lower-side plate 20b. The front-side tires 24 are rotatably supported at both end portions of the front-side axle 22 in the left-right direction.

The rear-side axle 23 is an axle member extending in the left-right direction, and is supported by a portion of the frame 20 near the rear end of the lower-side plate 20b. The rear-side tires 25 are rotatably supported at both end portions of the rear-side axle 23 in the left-right direction. Note that in the case of the present embodiment, the mobile crane 1 is a so-called two-axle type mobile crane including the front-side axle 22 and the rear-side axle 23. However, the mobile crane may be a so-called multi-axle type mobile crane having three or more axles.

The outrigger 26 includes a pair of front-side outriggers 26a and a pair of rear-side outriggers 26b. The pair of front-side outriggers 26a are supported by the pair of front-side outrigger support portions 202 of the frame 20, respectively. In addition, the pair of rear-side outriggers 26b are supported by the pair of rear-side outrigger support portions 203 of the frame 20, respectively.

In addition, the mobile crane 1 of the present embodiment includes the high-voltage system 3. The high-voltage system 3 is a system for executing traveling of the lower traveling body 2 and a motion other than traveling (for example, a crane operation and/or heating) on the basis of the electric power supplied from the high-voltage battery 30 to be described below. Hereinafter, the configuration of the high-voltage system 3 will be described.

Note that although illustration and detailed description are omitted, the mobile crane 1 of the present embodiment also includes a low-voltage system. The low-voltage system is a system for executing predetermined processing on the mobile crane 1 on the basis of the electric power supplied from a low-voltage battery (not illustrated) having a voltage lower than that of the high-voltage battery 30. In addition, the low-voltage system is also a system for transmitting a control signal for causing the mobile crane 1 to execute predetermined processing.

As illustrated in FIG. 2, the high-voltage system 3 includes, as main elements, the high-voltage battery 30, a lower junction box 31, a traveling inverter 33, a traveling motor 34, a slip ring 35, and an upper device 39.

The high-voltage battery 30 corresponds to an example of a power supply unit, and includes a plurality of batteries 301a, 301b, 302a, and 302b. The batteries 301a and 301b are disposed in the battery housing space 201 of the frame 20. As described above, in the case of the present embodiment, the dead space of the frame 20 can be effectively utilized, so that the high-voltage battery 30 can be compactly disposed, and damage due to impact or the like of the high-voltage battery 30 can be suppressed. In addition, the batteries 302a and 302b are disposed outside the frame 20 and above the batteries 301a and 301b.

The lower junction box 31 is used to distribute the electric power supplied from the high-voltage battery 30. The lower junction box 31 includes at least a junction box 312.

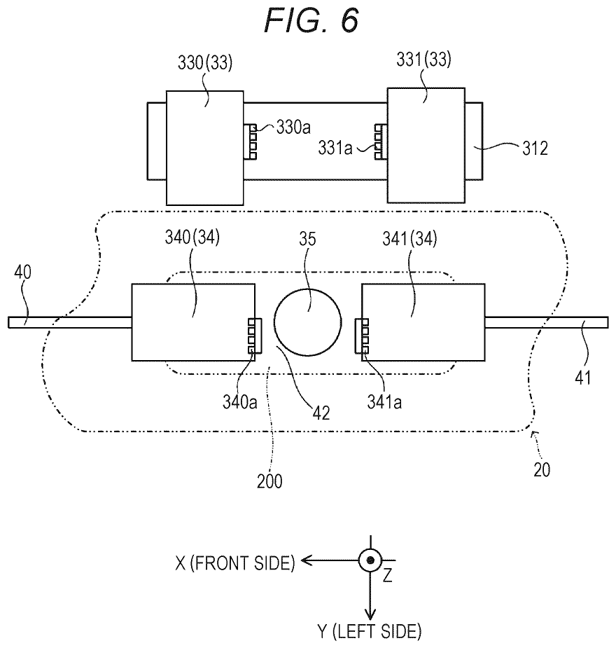

As illustrated in FIG. 6, the junction box 312 is disposed outside the frame 20. Specifically, the junction box 312 is disposed on the left or right side (in the case of the present embodiment, the right side) of the frame 20 and at a position matching the slip ring arrangement space 200 in the front-rear direction.

The junction box 312 is fixed to the frame 20 via a fixing device such as a bracket. The junction box 312 is connected to the first batteries 301a and 301b and the second batteries 302a and 302b via cables (not illustrated).

In addition, the junction box 312 is connected to the traveling inverter 33 via a cable (not illustrated). Furthermore, the junction box 312 is connected to the slip ring 35 via a cable (not illustrated). Note that the junction box 312 may be connected to another element provided in the lower traveling body 2.

The slip ring 35 is used to send the electric power of the high-voltage battery 30 supplied from the junction box 312 from the lower traveling body 2 to the upper turning body 5. In addition, the slip ring 35 is also used to send a current flowing through the low-voltage system and a control signal from the lower traveling body 2 to the upper turning body 5.

In addition, the upper device 39 is a device that is provided in the upper turning body 5 and operates on the basis of the electric power of the high-voltage battery 30. Note that in a case where the turning actuator is an electric motor, the electric motor for turning corresponds to an example of the upper device. In addition, in a case where the winch actuator is an electric motor, the electric motor for winch corresponds to an example of the upper device. In this case, the slip ring 35 is connected to the electric motor for turning and the electric motor for winch via an upper junction box (not illustrated). An inverter for turning may be provided between the upper junction box and the electric motor for turning. In addition, an inverter for winch may be provided between the upper junction box and the electric motor for winch. Such an upper junction box has a function of allocating the electric power of the high-voltage battery 30 supplied via the slip ring 35 to the electric motor for turning and the electric motor for winch.

When the electric power of the high-voltage battery 30 is supplied, the electric motor for turning is driven on the basis of the electric power. Then, the electric motor for turning turns the upper turning body 5.

In addition, when electric power of the high-voltage battery 30 is supplied, the electric motor for winch is driven on the basis of the electric power. Then, the electric motor for winch rotates a winch (not illustrated). As a result, the wire rope 56 is wound up or unwound, and the hook 57 ascends or descends.

As illustrated in FIG. 6, the traveling inverter 33 includes a front-side inverter 330 and a rear-side inverter 331. The front-side inverter 330 and the rear-side inverter 331 are provided outside the frame 20. Specifically, the front-side inverter 330 and the rear-side inverter 331 are provided on the left or right side (in the case of the present embodiment, the right side) of the frame 20 and at positions matching the slip ring arrangement space 200 in the front-rear direction.

In the case of the present embodiment, the front-side inverter 330 and the rear-side inverter 331 are disposed above the junction box 312 in a state of being aligned in the front-rear direction. The front-side inverter 330 and the rear-side inverter 331 are provided alongside a front-side traveling motor 340 and a rear-side traveling motor 341 to be described below. The front-side inverter 330 corresponds to an example of a first inverter. The rear-side inverter 331 corresponds to an example of a second inverter.

The front-side inverter 330 includes a front-side terminal 330a. The front-side terminal 330a of the front-side inverter 330 faces rearward. The front-side terminal 330a of the front-side inverter 330 is directed in the direction opposite to the front-side terminal 340a of the front-side traveling motor 340 to be described below. On the other hand, the rear-side inverter 331 has a rear-side terminal 331a. The rear-side terminal 331a of the rear-side inverter 331 faces forward. The rear-side terminal 331a of the rear-side inverter 331 faces in the direction opposite to a rear-side terminal 341a of the rear-side traveling motor 341. Note that the position of the terminal of the front-side inverter and the position of the terminal of the rear-side inverter are not limited to the case of the present embodiment.

The front-side terminal 330a of the front-side inverter 330 and the front-side terminal 340a of the front-side traveling motor 340 are connected by a front-side cable (not illustrated). In addition, the rear-side terminal 331a of the rear-side inverter 331 and the rear-side terminal 341a of the rear-side traveling motor 341 are connected by a rear-side cable (not illustrated).

In the case of the present embodiment, the junction box 312 and the traveling inverter 33 are disposed to overlap each other in the up-down direction in a predetermined region of the lower traveling body 2. In the case of the present embodiment, the predetermined region is one side of the frame 20 in the left-right direction and is a predetermined position (for example, a center position in the front-back direction) of the frame 20 in the front-rear direction. Such a configuration contributes to space saving.

Note that the junction box 312 and the traveling inverter 33 may be unitized by being housed in one casing or by being releasably integrated with a fastening component such as a bolt. In addition, the junction box 312 may be provided above the traveling inverter 33. In addition, although not illustrated, the traveling inverter may be disposed, for example, in the frame. In a case where the traveling inverter is disposed in the frame, the traveling inverter may be disposed above, below, or on a side of the traveling motor. In a case where the traveling inverter is disposed in the frame and above or below the traveling motor, the terminal of the traveling inverter and the terminal of the traveling motor face each other in the front-rear direction, so that it is easy to configure the cable connecting the traveling inverter and the traveling motor so as not to pass through a space 42 to be described below.

Such a traveling inverter 33 (the front-side inverter 330 and the rear-side inverter 331) adjusts the current received from the junction box 312 and sends the adjusted current to the traveling motor 34 (the front-side traveling motor 340 and the rear-side traveling motor 341).

Note that the traveling inverter may be incorporated in the traveling motor. That is, the traveling motor (the front-side traveling motor and the rear-side traveling motor) may be an inverter-integrated motor. Specifically, the front-side traveling motor may be an inverter-integrated motor in which a front-side inverter is incorporated. In addition, the rear-side traveling motor may be an inverter-integrated motor in which a rear-side inverter is incorporated.

The traveling motor 34 includes the front-side traveling motor 340 and the rear-side traveling motor 341. The front-side traveling motor 340 and the rear-side traveling motor 341 are provided below the frame 20. Each of the front-side traveling motor 340 and the rear-side traveling motor 341 is fixed to the lower-side plate 20b of the frame 20 via a fixing device such as a bracket. The front-side traveling motor 340 corresponds to an example of a first motor. The rear-side traveling motor 341 corresponds to an example of a second motor.

Note that a portion of the lower-side plate 20b of the frame 20 to which at least the front-side traveling motor 340 and the rear-side traveling motor 341 are fixed may have a shape recessed upward along the outer shapes of the front-side traveling motor 340 and the rear-side traveling motor 341. In a case where the lower-side plate 20b of the frame 20 is recessed upward, a part including the upper end portions of the front-side traveling motor 340 and the rear-side traveling motor 341 is positioned above the lower surface of the frame 20. That is, the front-side traveling motor 340 and the rear-side traveling motor 341 partially overlap the frame 20 in the up-down direction. According to such a configuration, space saving can be achieved.

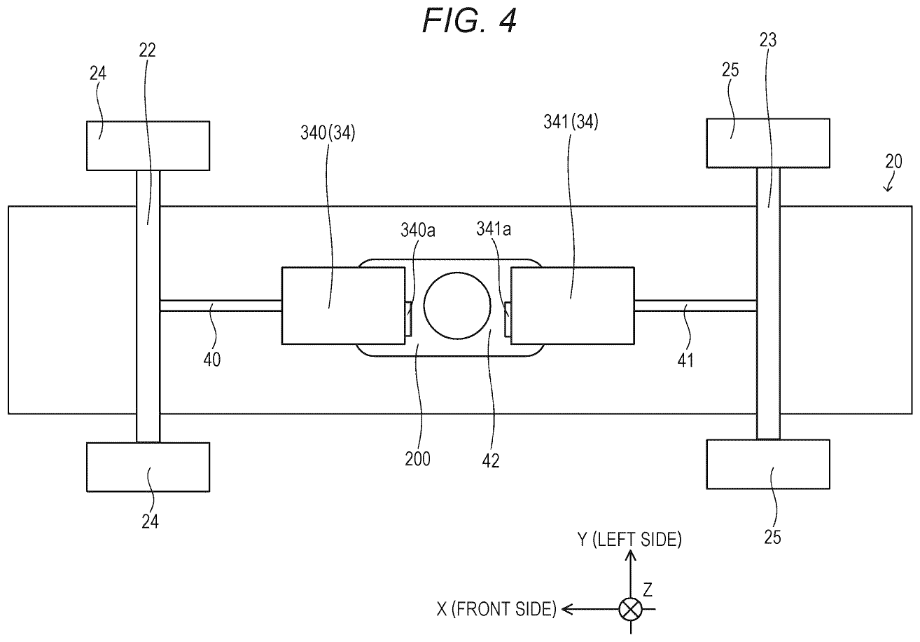

In addition, as illustrated in FIG. 4, the front-side traveling motor 340 and the rear-side traveling motor 341 are provided between the front-side axle 22 and the rear-side axle 23 in a state of being aligned in the front-rear direction.

The output shaft of the front-side traveling motor 340 is connected to a front-side driving shaft 40. The output shaft of the front-side traveling motor 340 and the front-side driving shaft 40 extend in the front-rear direction. The front-side driving shaft 40 is a shaft extending in the front-rear direction, and is provided between the front-side traveling motor 340 and the front-side axle 22. Note that in the case of the present embodiment, the output shaft of the front-side traveling motor 340 and the front-side driving shaft 40 are slightly inclined with respect to the front-rear direction (X direction).

The front end portion of the front-side driving shaft 40 is connected to the front-side axle 22 via a gear (for example, a speed reducer). The rear end portion of the front-side driving shaft 40 is connected to the output shaft of the front-side traveling motor 340. The front-side driving shaft 40 transmits the rotation of the front-side traveling motor 340 to the front-side axle 22.

The rear-side traveling motor 341 is disposed behind the front-side traveling motor 340. The output shaft of the rear-side traveling motor 341 is connected to a rear-side driving shaft 41. The output shaft of the rear-side traveling motor 341 and the rear-side driving shaft 41 extend in the front-rear direction. The rear-side driving shaft 41 is a shaft extending in the front-rear direction, and is provided between the rear-side traveling motor 341 and the rear-side axle 23. Note that in the case of the present embodiment, the output shaft of the rear-side traveling motor 341 and the rear-side driving shaft 41 are inclined at a predetermined angle with respect to the front-rear direction (X direction).

The front end portion of the rear-side driving shaft 41 is connected to the output shaft of the rear-side traveling motor 341. The rear end portion of the rear-side driving shaft 41 is connected to the rear-side axle 23 via a gear (for example, a speed reducer). The rear-side driving shaft 41 transmits the rotation of the rear-side traveling motor 341 to the rear-side axle 23.

In the case of the present embodiment, the position of the front-side traveling motor 340 in the front-rear direction can be adjusted according to the length of the front-side driving shaft 40. In addition, the position of the rear-side traveling motor 341 in the front-rear direction can be adjusted according to the length of the rear-side driving shaft 41. Therefore, the weight balance of the entire mobile crane 1 can be flexibly adjusted according to the specifications of the mobile crane 1.

In the case of the present embodiment, the front-side traveling motor 340 and the rear-side traveling motor 341 are disposed in a state where the output shaft extends in the front-rear direction. However, the arrangement mode of the front-side traveling motor 340 and the rear-side traveling motor 341 is not limited to the arrangement mode of the present embodiment. The front-side traveling motor 340 and the rear-side traveling motor 341 may be disposed in a state where the output shaft is inclined with respect to the front-rear direction. Specifically, the front-side traveling motor 340 and the rear-side traveling motor 341 may be disposed in a state where the output shaft is inclined by 90° with respect to the front-rear direction (that is, a state where the output shaft coincides with the left-right direction).

In the case of the present embodiment, the space 42 is provided between the rear-side traveling motor 341 and the front-side traveling motor 340 in the front-rear direction. The space 42 is also a region (the lower region of the slip ring 35) provided below the slip ring 35 to be described below. That is, the front-side traveling motor 340 and the rear-side traveling motor 341 are disposed to face each other in the front-rear direction with the lower region of the slip ring 35 interposed therebetween.

The front-side traveling motor 340 includes the front-side terminal 340a at the rear end portion. The front-side terminal 340a of the front-side traveling motor 340 is disposed so as to face forward. In other words, the front-side terminal 340a of the front-side traveling motor 340 faces in the direction (front) opposite to the direction (rear) in which the space 42 exists, with reference to the front-side terminal 340a. The front-side terminal 340a corresponds to an example of a power supply terminal.

In addition, the rear-side traveling motor 341 includes the rear-side terminal 341a at the front end portion. The rear-side terminal 341a of the rear-side traveling motor 341 is disposed so as to face rearward. In other words, the rear-side terminal 341a of the rear-side traveling motor 341 faces in the direction (rear) opposite to the direction (front) in which the space 42 exists, with reference to the rear-side terminal 341a. The rear-side terminal 341a corresponds to an example of the power supply terminal.

The front-side cable (not illustrated) connected to the front-side terminal 340a of the front-side traveling motor 340 is routed so as not to pass through the space 42. In the case of the present embodiment, the front-side terminal 340a of the front-side traveling motor 340 is disposed to face forward, so that it is easy to route the front-side cable so as not to pass through the space 42. The front-side cable corresponds to an example of a power cable, and is a cable that connects the front-side traveling motor 340 and the front-side inverter 330.

In addition, a rear-side cable (not illustrated) connected to the rear-side terminal 341a of the rear-side traveling motor 341 is also routed so as not to pass through the space 42. In the case of the present embodiment, the rear-side terminal 341a of the rear-side traveling motor 341 is disposed to face rearward, so that it is easy to route the rear-side cable so as not to pass through the space 42. The rear-side cable corresponds to an example of the power cable, and is a cable that connects the rear-side traveling motor 341 and the rear-side inverter 331.

Note that in a case where each of the front-side traveling motor and the rear-side traveling motor is an inverter-integrated motor, the cables connecting the front-side traveling motor and the rear-side traveling motor to the lower junction box are routed so as not to pass through the space 42.

In addition, in the space 42, a slip ring cable (not illustrated) connected to the slip ring 35 to be described below is disposed. The slip ring cable corresponds to an example of the power cable.

When performing maintenance of the front-side traveling motor 340, the rear-side traveling motor 341, and the slip ring 35 as described above, a maintenance operator can access the front-side traveling motor 340, the rear-side traveling motor 341, and the slip ring 35 from below the space 42. Then, the maintenance operator performs a maintenance operation in the space 42. At this time, the front-side cable and the rear-side cable are not disposed in the space 42, so that the efficiency of the maintenance operation can be improved.

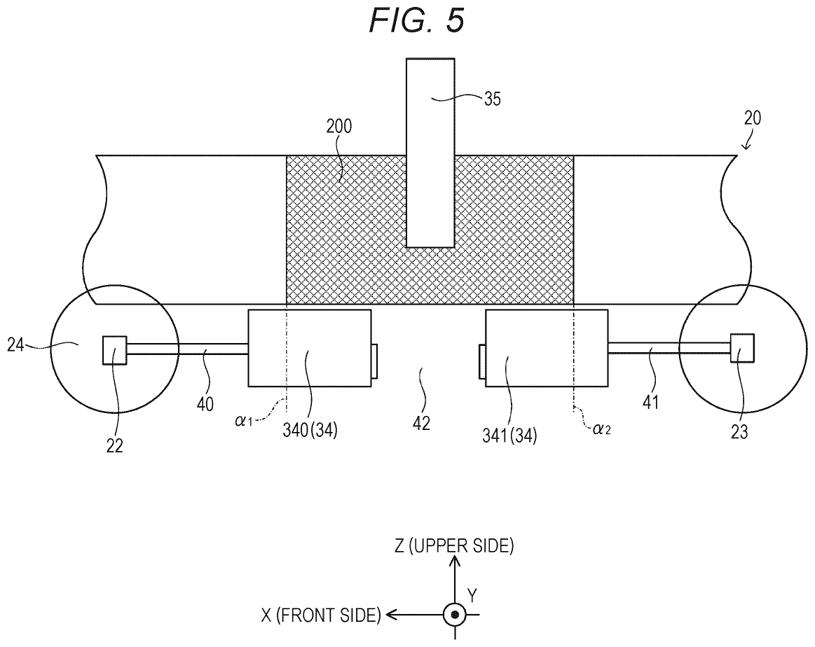

In addition, as illustrated in FIG. 5, each of the rear-side traveling motor 341 and the front-side traveling motor 340 is disposed to at least partially overlap with a region (a region existing between a one-dot chain line α₁ and a one-dot chain line α₂ in FIG. 6) obtained by extending the slip ring arrangement space 200 (a portion indicated by a slant lattice in FIG. 5) downward.

The front-side traveling motor 340 and the rear-side traveling motor 341 having the above-described configurations are driven on the basis of the electric power supplied from the high-voltage battery 30 under the control of a control unit (not illustrated). The control unit has a function of adjusting the torque of each of the front-side traveling motor 340 and the rear-side traveling motor 341. For example, the traveling performance of the mobile crane 1 can be improved by the control unit adjusting the torque of each of the front-side traveling motor 340 and the rear-side traveling motor 341 according to the situation of the traveling path. The control unit can easily adjust the torque of each of the front-side traveling motor 340 and the rear-side traveling motor 341 by controlling the current supplied to each of the front-side traveling motor 340 and the rear-side traveling motor 341.

As described above, in the case of the present embodiment, the front-side traveling motor 340 and the rear-side traveling motor 341 are disposed at the central portion in the left-right direction and the intermediate portion in the front-rear direction of the lower traveling body 2 to be aligned in the front-rear direction. However, the positions of the front-side traveling motor 340 and the rear-side traveling motor 341 are not limited to the above-described positions. For example, the front-side traveling motor 340 and the rear-side traveling motor 341 may be disposed closer to one side in the left-right direction than the central portion of the lower traveling body 2 in the left-right direction. The position of the center of gravity of the mobile crane 1 can be adjusted by adjusting the positions of the front-side traveling motor 340 and the rear-side traveling motor 341 in the left-right direction and/or the front-rear direction.

Note that in a case where the mobile crane 1 is a so-called multi-axle vehicle having three or more axles, the mobile crane 1 may include, for example, the same number of traveling motors as the number of axles. However, in a case where the mobile crane 1 is a multi-axle vehicle, the number of axles and the number of traveling motors may be different.

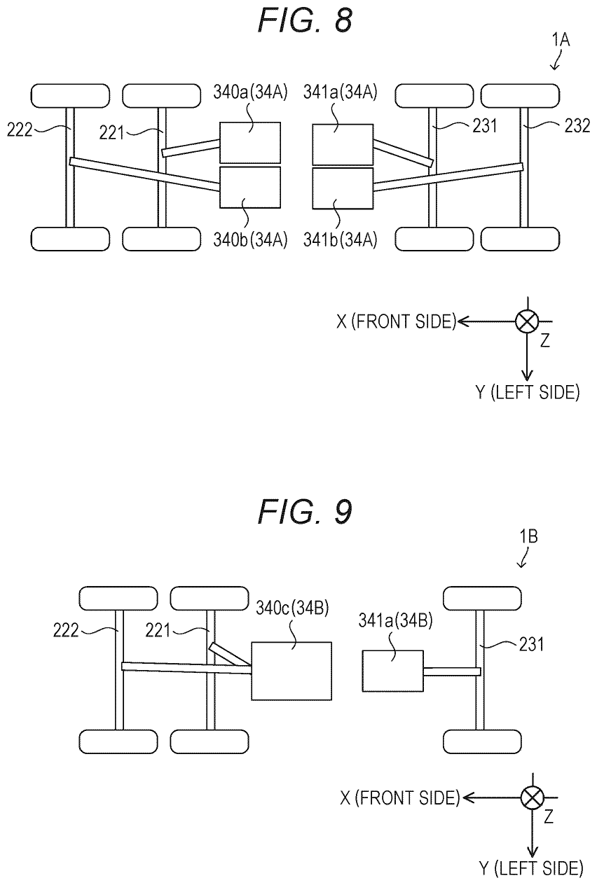

FIGS. 8 and 9 are schematic views illustrating an example of the multi-axle vehicle. FIGS. 8 and 9 are schematic views illustrating the mobile crane as viewed from above.

First, a mobile crane 1A illustrated in FIG. 8 has two front-side axles 221 and 222 and two rear-side axles 231 and 232.

In addition, the mobile crane 1A includes a traveling motor 34A. Specifically, the traveling motor 34A includes two front-side traveling motors 340a and 340b and two rear-side traveling motors 341a and 341b. That is, in the case of the present example, the mobile crane 1A includes the same number of front-side traveling motors as that of the front-side axles and the same number of rear-side traveling motors as that of the rear-side axles.

The front-side traveling motors 340a and 340b and the rear-side traveling motors 341a and 341b are provided below the frame 20 (see FIGS. 3 to 5). Each of the front-side traveling motors 340a and 340b corresponds to an example of the first motor. Each of the rear-side traveling motors 341a and 341b corresponds to an example of the second motor.

In addition, as illustrated in FIG. 8, the front-side traveling motors 340a and 340b and the rear-side traveling motors 341a and 341b are provided between the front-side axle 221 and the rear-side axle 231. In addition, the front-side traveling motor 340a and the front-side traveling motor 340b are disposed to be aligned in the left-right direction. The rear-side traveling motor 341a and the rear-side traveling motor 341b are disposed to be aligned in the left-right direction. In addition, the front-side traveling motors 340a and 340b and the rear-side traveling motors 341a and 341b are disposed to be aligned in the front-rear direction.

The front-side traveling motor 340a is connected to the front-side axle 221. Therefore, the front-side axle 221 is driven on the basis of the power of the front-side traveling motor 340a. The front-side traveling motor 340b is connected to the front-side axle 222. Therefore, the front-side axle 222 is driven on the basis of the power of the front-side traveling motor 340b.

The rear-side traveling motor 341a is connected to the rear-side axle 231. Therefore, the rear-side axle 231 is driven on the basis of the power of the rear-side traveling motor 341a. The rear-side traveling motor 341b is connected to the rear-side axle 232. Therefore, the rear-side axle 232 is driven on the basis of the power of the rear-side traveling motor 341b. Other configurations of the mobile crane 1A are substantially similar to those of the mobile crane 1 according to the above-described embodiment.

In the case of the mobile crane 1A having the above configuration, the front-side traveling motors 340a and 340b and the rear-side traveling motors 341a and 341b are integrated in the central portion of the frame 20 (see FIG. 3), so that the maintenance operation of the traveling motor and the like can be efficiently performed in the multi-axle vehicle having a plurality of axles.

Next, a mobile crane 1B illustrated in FIG. 9 has two front-side axles 221 and 222 and one rear-side axle 231.

In addition, the mobile crane 1B includes a traveling motor 34B. Specifically, the traveling motor 34B includes one front-side traveling motor 340c and one rear-side traveling motor 341a. That is, in the case of the present example, the mobile crane 1A includes the smaller number of front-side traveling motors than that of the front-side axles and the smaller number of rear-side traveling motors than that of the rear-side axles.

The front-side traveling motor 340c is a motor having performance higher than the performance of the rear-side traveling motor 341a. In addition, the outer diameter of the front-side traveling motor 340c is larger than the outer diameter of the rear-side traveling motor 341a. Note that the performance of the rear-side traveling motor 341a is the same as the performance of the rear-side traveling motor 341a illustrated in FIG. 8.

The front-side traveling motor 340c and the rear-side traveling motor 341a are provided below the frame 20 (see FIGS. 3 to 5). The front-side traveling motor 340c corresponds to an example of the first motor. The rear-side traveling motor 341a corresponds to an example of the second motor.

In addition, as illustrated in FIG. 9, the front-side traveling motor 340c and the rear-side traveling motor 341a are provided between the front-side axle 221 and the rear-side axle 231. In addition, the front-side traveling motor 340c and the rear-side traveling motor 341a are disposed to be aligned in the front-rear direction.

The front-side traveling motor 340c is connected to the front-side axle 221 and the front-side axle 222. Therefore, the front-side axle 221 and the front-side axle 222 are driven on the basis of the power of the front-side traveling motor 340c. In addition, driving shafts 403 and 404 are connected to the traveling motor 34 via gears (transfer gears or the like).

The rear-side traveling motor 341a is connected to the rear-side axle 231. Therefore, the rear-side axle 231 is driven on the basis of the power of the rear-side traveling motor 341a. Other configurations of the mobile crane 1B are substantially similar to those of the mobile crane 1 according to the above-described embodiment and the mobile crane 1A illustrated in FIG. 8.

Also in the case of the mobile cranes 1A and 1B having the above configuration, the front-side traveling motor 340c and the rear-side traveling motor 341a are integrated at the central portion of the frame 20 (see FIG. 3), so that the maintenance operation of the traveling motor and the like can be efficiently performed in the multi-axle vehicle having a plurality of axles.

In addition, in the case of the present embodiment, no speed reducer is provided between the front-side traveling motor 340 and the front-side driving shaft 40 and between the rear-side traveling motor 341 and the rear-side driving shaft 41. However, a speed reducer may be provided between the front-side traveling motor and the front-side driving shaft and/or between the rear-side traveling motor and the rear-side driving shaft according to the specifications of the front-side traveling motor and the rear-side traveling motor.

In addition, in the case of the present embodiment, each of the front-side driving shaft 40 and the rear-side driving shaft 41 is constituted by a shaft extending in the front-rear direction. However, the front-side driving shaft and/or the rear-side driving shaft may be constituted by a plurality of shafts connected at a predetermined angle.

In addition, the traveling motor may be constituted by one electric motor. Also in this case, one electric motor may be disposed below the frame 20 and between the front-side axle 22 and the rear-side axle 23. In a case where the traveling motor is constituted by one electric motor, the electric motor may be connected to the front-side driving shaft and the rear-side driving shaft via a power distribution device such as a transfer. In addition, a transmission may be provided between the front-side traveling motor 340 and the rear-side traveling motor 341, and the front-side axle 22 and the rear-side axle 23 as necessary.

### <Effects of Present Embodiment>

According to the present embodiment having the above configuration, it is possible to realize the mobile crane 1 capable of traveling on the basis of the electric power of the high-voltage battery 30. In addition, functions and effects exhibited by the mobile crane 1 according to the present embodiment are as described above.

The entire disclosure of the specification, drawings, and abstract included in Japanese Patent Application No. 2022-102119 filed on Jun. 24, 2022 is incorporated herein by reference.

### INDUSTRIAL APPLICABILITY

The crane according to the present invention is not limited to a rough terrain crane and may be various mobile cranes such as an all-terrain crane, a truck crane, and a loading truck crane (also referred to as a cargo crane).

### REFERENCE SIGNS LIST

1, 1A, 1 Mobile crane
2 Lower traveling body
20 Frame
20a Upper-side plate
20b Lower-side plate
20c Left-side plate
20d Right-side plate
20e Front-side plate
20f Rear-side plate
200 Slip ring arrangement space
201 Battery housing space
202 Front-side outrigger support portion
203 Rear-side outrigger support portion
21 Body
22, 221, 222 Front-side axle
23, 231, 232 Rear-side axle
24 Front-side tire
25 Rear-side tire
26 Outrigger
26a Front-side outrigger
26b Rear-side outrigger
3 High-voltage system
30 High-voltage battery
301a, 301b First battery
302a, 302b Second battery
31 Lower junction box
312 Junction box
33 Traveling inverter
330 Front-side inverter
330a Front-side terminal
331 Rear-side inverter
331a Rear-side terminal
34, 34A, 34B Traveling motor
340, 340a, 340b, 340c Front-side traveling motor
340a Front-side terminal
341, 341a, 341b Rear-side traveling motor
341a Rear-side terminal
35 Slip ring
40 Front-side driving shaft
41 Rear-side driving shaft
42 Space
5 Upper turning body
51 Turning table
52 Telescopic boom
53 Cab
54 Derricking cylinder
55 Telescopic cylinder
56 Wire rope
57 Hook
58 Winch

1. A crane having a turning body that supports a boom, the crane comprising:
a travel body that has a frame for supporting a front-side axle and a rear-side axle; and
a motor that is disposed below the frame and between the front-side axle and the rear-side axle, the motor being connected to the front-side axle and the rear-side axle.

2. The crane according to claim 1, wherein the motor includes a first motor connected to the front-side axle and a second motor connected to the rear-side axle.

3. The crane according to claim 2, further comprising:
a power supply unit that is provided in the travel body; and
a slip ring that supplies electric power of the power supply unit to the turning body, wherein the first motor and the second motor are disposed to face each other with a lower region of the slip ring interposed therebetween.

4. The crane according to claim 3, wherein
the frame has a through hole surrounding the slip ring, and
the first motor and the second motor are disposed to at least partially overlap with a region extending downward from the through hole.

5. The crane according to claim 3, further comprising: a first inverter and a second inverter that are provided alongside the first motor and the second motor, respectively, and are connected to the power supply unit, wherein
cables connecting the first motor and the second motor to the first inverter and the second inverter are routed so as not to pass through the lower region.

6. The crane according to claim 5, further comprising: a junction box that is provided above or below the first inverter and the second inverter and distributes electric power of the power supply unit to the first inverter and the second inverter.

7. The crane according to claim 3, further comprising: a junction box that is provided alongside each of the first motor and the second motor, respectively, and distributes power of the power supply unit to the first motor and the second motor, wherein
each of the first motor and the second motor is an inverter-integrated motor, and
cables connecting the first motor and the second motor to the junction box are routed so as not to pass through the lower region.

8. The crane according to claim 1, further comprising: an inverter that is housed above the motor and in the frame.
